(19) United States
(12) Patent Application Publication
(10) Pub. No.: US 2007/0012253 A1
(43) Pub. Date: Jan. 18, 2007

(54) Structure of improving feeding device

(76) Inventor: Guang-hong Zheng, Taipei City (TW)

Correspondence Address: Guang-hong Zheng, apt 3D, 3620 168th St., Flushing, NY, 11358, US

(21) Appl. No.: 11/181,663

(22) Filed: Jul. 15, 2005

(51) Int. Cl. A01K 39/00

(52) U.S. Cl. 119/51.02

(57) ABSTRACT

An improving structure of a feeding device of the present invention, comprising: a feeding device, an electrical controlling circuit, wherein a network signal transmitting interface is located at a side surface of the feeding device, the network signal transmitting interface can be an existing circuit socket or a wireless transmitting antenna, or even both, the network signal transmitting interface provides an external connection for an Internet system. A feeding outlet is located inside the feeding device so that a feeding process can be proceeded by a pre-set signal. The electrical controlling circuit comprises a wire network interface or a wireless network interface connected to a signal transmitting socket or a wireless transmitting antenna, a memory card for storing program and a central possessor for controlling the feeding outlet, the control signal is processed by the central possessor to drive the feeding outlet to provide feeds, the feeding device is controlled to produce feeds to a pet at a suitable time.

### BACKGROUND OF THE INVENTION

1. Field of Invention

The present invention relates generally to a structure of an improving feeding device. More particularly, the present invention relates to a feeding device that can be controlled through an Internet or regional network locating a far distance.

2. Description of the Related Art

Refer to FIG. 1, a structure of a conventional feeding device, a timing device is located within a feeding device 10, wherein the timing device is set to trigger the feeding device to release feed in accordance with pre-set time. The feed will be released from the feeding device 10 through a feeding outlet 102 into a feeding plate 103. Thus, the feeding device can be set to release the feed according to the set-time. However, the conventional feeding device suffered some practical problem with its pre-set timing to release feed. The problems such as the feeding plate 103 is overturned or the feed inside of the feeding plate 103 is contaminated with animals' feces as a result, the pets cannot be fed properly when the owners are far away from home. Thus, it is an object of the present invention to provide an improving feeding device that can resolve those inconvenience and defects of the conventional feeding device.

### SUMMARY OF THE INVENTION

It is an object of the present invention to provide an improving feeding device that comprises an electrical controlling circuit, wherein the electrical controlling circuit further comprises a wire or wireless network interface, a memory card storing programs and a central possessor that can control a pre-set feeding outlet. The network interface can provides an external connection to an Internet system that can control the feeding device from a far distance. The central possessor can proceed the programs stored within the memory card to initiate the feeding outlet to release feed for the pets. Therefore it is another object of the present invention that the owner can control and proceed the feeding process from a far distance through the Internet.

These and other objects of the present invention will become readily apparent upon further review of the following specification and drawings

### BRIEF DESCRIPTION OF THE DRAWING

The accompanying drawings are included to provide a further understanding of the present invention, and are incorporated in and constitutes a part of this specification. The drawings illustrate embodiments of the invention and, together with the description, serve to explain the principles of the invention. In the drawings,

FIG. 1 is a perspective view of a conventional feeding device of a prior art;

FIG. 2 is a perspective view of an improving feeding device of a preferred embodiment of the present invention;

FIG. 3 is a perspective view of an improving feeding device of another preferred embodiment of the present invention;

FIG. 4 is a diagram of first practical example of utilizing the improving feeding device of the present invention;

FIG. 5 is a diagram of second practical example of utilizing the improving feeding device of the present invention;

FIG. 6 is a block diagram of an electrical controlling circuit of the improving feeding device of the present invention.

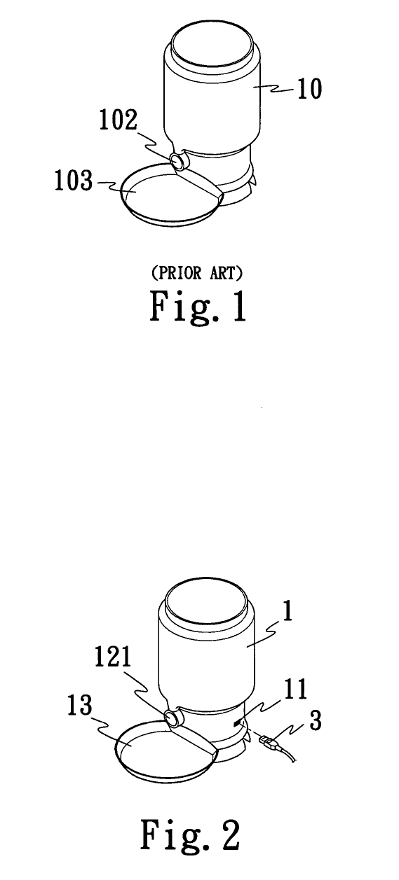

### DESCRIPTION OF THE REFERRED EMBODIMENTS

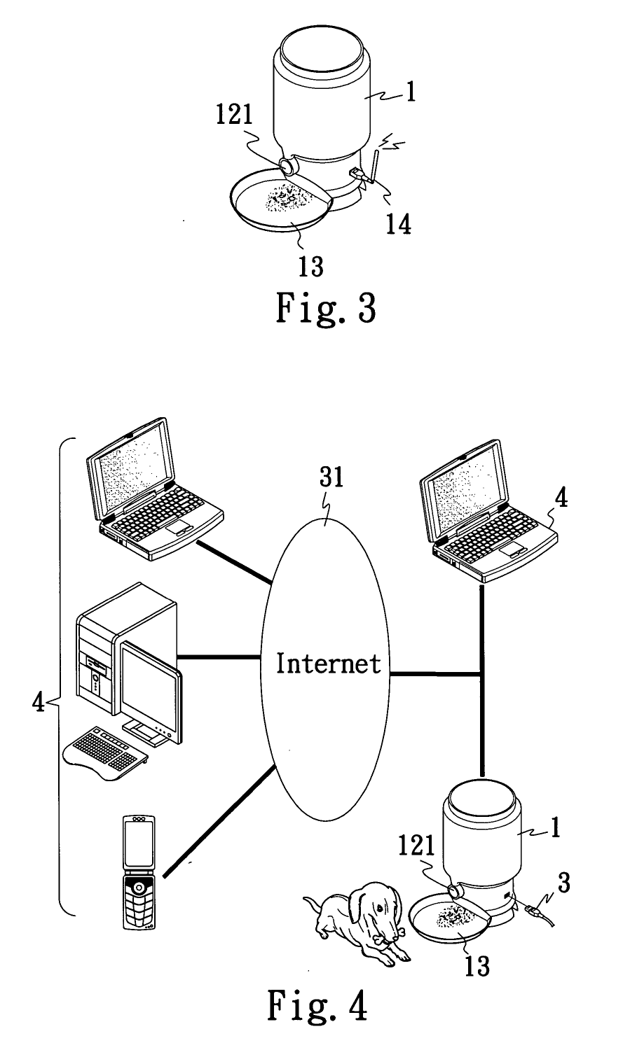

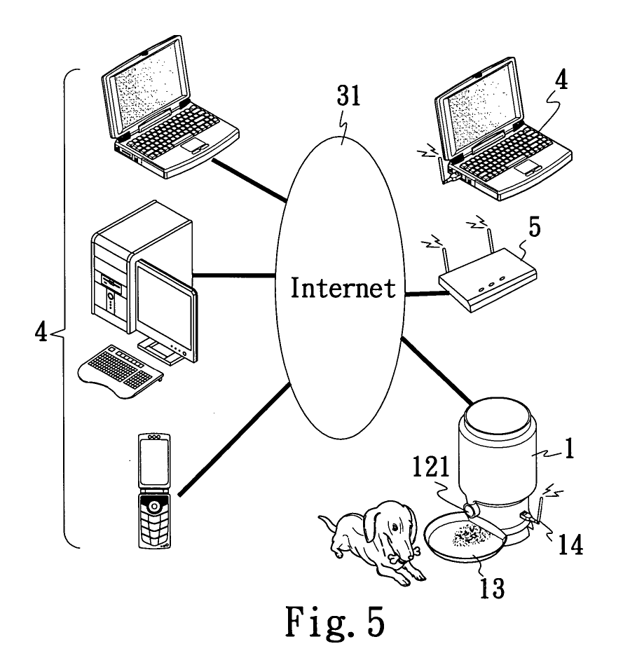

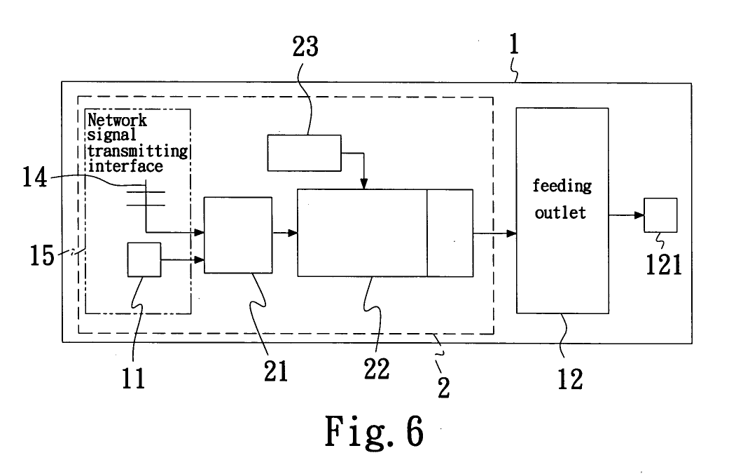

FIGS. 2 and 3 illustrate perspective views of a structure of a feeding device of a preferred embodiment of the present invention. Refer to FIG. 4, showing a diagram of a first practical example of utilizing the feeding device of the present invention. FIG. 5 shows a second practical example of utilizing the feeding device of the present invention. FIG. 6 illustrates a block diagram of an electrical controlling circuit. The feeding device of the present invention comprises a feeding device 1 and an electrical controlling circuit 2, wherein an interface of transmitting network signals 15 is located at a side of the feeding device 1. The interface of transmitting network signals 15 can be an existing circuit socket 11 or a wireless transmitting amtenna 14 or even can be both of the existing circuit socket 11 and the wireless transmitting antenna 14. A feeding outlet 12 is installed inside the feeding device 1 and is able to receive a pre-set control signal in order to providing food through an output opening 121 to the pets.

A feeing plate 13 is placed below the output opening 121 as shown on FIGS. 4 and 5. The electrical controlling circuit 2 comprises a wire or a wireless network interface 21, a central processor 22 and a memory card 23, wherein the network interface 21 is combined with the existing circuit socket 1 of the feeding device 1 or the wireless transmitting antenna 14 in order to provide an external connection to an Internet 31 for a network signal wire 3 or a wireless network station 5. The memory card 23 can store relative controlling program. The central processor 22 is connected to and located in between the network interface 21 and the feeding outlet 12. A far-end controlling device 4, such as a movable laptop or a cellular phone or a desk computer, input a control signal through the Internet 31, the network signal 3 or the wireless station 5 either by a wire or a wireless method to the network interface 21 and eventually to the central possessor 22. The central possessor 22 can process the stored program inside the memory card 23 and initiates the feeding outlet 12 by sending a controlling signal to release a reasonable amount of the feed at a specific time from the output opening 121.

The design of the feeding device of the present invention is inspired from the practical experience that modern technologies such as, the visual function of the Internet and cellular phones can be utilized with the feeding device to achieve a feeding process in a controllable and suitable condition and time in accordance with the actual feeding requirements of the pets.

FIG. 5 illustrates a second practical example of utilizing a feeding device in accordance with a second preferred embodiment of the present invention. The above-mentioned network interface 21 of the feeding device can be used as an interface for a wireless network system in order to achieve the connection between the feeding device to the network by connecting a wireless transmitting antenna 14 to the Internet 31.

It is obvious from the above-description of the improving feeding device that can be utilized and controlled through the Internet from a far distance. Thus the feeding device of the present invention fulfils the patentability of novelty and improvement.

While the invention has been described by the way of examples and in terms of a preferred embedment, it is to be understood that the invention need not be limited to the disclosed embodiment. On the contrary, it is intended to cover various modifications and similar arrangements included within the spirit and the scope of the appended claims. The scope of which should be accorded with the broadest interpretation so as to encompass all such modifications and similar structures.

What is claimed is:

1. An improving structure of a feeding device of the present invention, comprising:
a feeding device, having a network signal transmitting interface located at a side surface of the feeding device, wherein the network signal transmitting interface can be an existing circuit socket or a wireless transmitting antenna, or even both, the network signal transmitting interface can provide an external connection for an Internet system, a feeding outlet is located inside the feeding device so that a feeding process can be proceeded by a pre-set signal;
an electrical controlling circuit, having a wire network interface or a wireless network interface that is connected to a signal transmitting socket or a wireless transmitting antenna, a memory card for storing program and a central possessor for controlling the feeding outlet, wherein a control signal is sent out from a far location by utilizing the network interface to transmit the control signal through the network signal transmitting interface, and the control signal is accepted by the network signal transmitting interface and is stored in memory card, the control signal is then processed by the central possessor to drive the feeding outlet to provide feeds, wherein the feeding device is controlled to produce feeds to a pet at a suitable time.

2. The structure of claim 1, wherein the network interface of the electrical controlling circuit is a wireless network system.

3. The structure of claim 1, wherein the electrical controlling circuit can combine with a conventional wireless transmitting interface, such as an ultra red rays controller, to accept a control signal transmitted by a wireless transmission from a control device of a closed distance in order to control a feeding movement of the feeding outlet.

4. The structure of claim 1, wherein the control electric circuit can combine with a visual function of the Internet to achieve a feeding process in a controllable and suitable condition and suitable time in accordance with the actual feeding requirements of pets and environmental circumstances.
